(19) United States
(12) Patent Application Publication
(10) Pub. No.: US 2005/0173462 A1
(43) Pub. Date: Aug. 11, 2005

(54) Dispensing machine with portion control

(76) Inventors: Irvin H. Stumler, Louisville, KY (US); Eric Stumler, Louisville, KY (US); Michael C. Johnson, Louisville, KY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/067,297

(22) Filed: Feb. 25, 2005

Related U.S. Application Data
(63) Continuation of application No. 09/868,527, filed on Oct. 25, 2001, now abandoned.
(60) Provisional application No. 60/175,952, filed on Jan. 13, 2000.
(60) Provisional application No. 60/131,312, filed on Apr. 27, 1999.

(51) Int. Cl. B65D 35/28; B67D 5/40

(52) U.S. Cl. 222/380

(57) ABSTRACT

An automatic dispensing machine provides a portioning chamber, which is separate from the main dispensing chamber. In a preferred embodiment, it also provides a pneumatically-actuated suction to pull the main dispensing valve down to remove used product bags and insert new bags, and it provides an automatically-controlled lift platform to lift up new product to be Inserted into the cylinder. It also provides a dispensing valve design, which provides clean cut-off of product to minimize dripping.

This application claims priority from U.S. Provisional Applications Ser. No. 60/131,312, filed Apr. 27, 1999 and Ser. No. 60/175,952, filed Jan. 13, 2000. Ice cream dispensing machines are known, in which the ice cream or other product is placed in a cylinder, and a plunger moves along the cylinder, pushing the product out a spout. A known machine is shown in U.S. Pat. No. 5,421,484 “Beach”, which is hereby incorporated by reference. These machines are operated by a person pulling a lever. While the lever is being pulled, it causes a valve to open to provide air pressure, which causes the plunger to move in the cylinder, dispensing the ice cream. Pulling the lever also opens a dispensing valve, so the product which is being pushed by the plunger can leave the machine through the dispensing valve. Usually, the machine has more than one cylinder, each cylinder having its own control lever, and each cylinder being independently operated.

### BACKGROUND OF THE INVENTION

The problem with these prior art machines is that they provide no portion control. The amount of product that is dispensed depends on the individual operator. One operator may dispense large servings, and another operator may dispense small servings, so there is no consistency in the serving size. This also means that the price being charged for the serving may be too much or too little, depending upon the size of the serving that is dispensed. Also, this arrangement is not suitable for automatic dispensing from a coin-operated dispenser.

The problem of coming up with an economical, reliable, automatic dispensing machine has been considered for several years by various companies, but nobody has yet designed a practical solution. The portions cannot be measured accurately by weighing the cone or cup into which the product is dispensed, because part of the portion being dispensed is still suspended form the dispenser. The portions cannot be measured by measuring flow rate, because the viscosity of the fluid changes dramatically with slight changes in ambient conditions or slight changes in temperature or recipe. It is difficult to measure accurately by measuring the distance dispenser plunger represents a large volume.

### SUMMARY OF THE INVENTION

The purpose of the present invention is to provide simple, accurate, economical, reliable, easily cleaned, automatic portion control for dispensing machines.

The present invention accurately measures the volume of product that is dispensed. Rather than measuring the distance traveled by the main, large plunger, a second smaller-diameter portioning plunger is provided, which can be more accurately controlled. The portioning plunger may have only a single stop for dispensing only a single portion size at a time, or multiple stops may be provided to permit different portion sizes.

### BRIEF DESCRIPTION OF THE DRAWINGS

FIG. 1 is a front view of a dispensing machine made in accordance with the present invention;

FIG. 2 is a front sectional view of the machine of FIG. 1;

FIG. 3 is a side view of the machine of FIG. 1;

FIG. 4 is a side sectional view partially broken away form the machine of FIG. 1;

FIG. 5 is a schematic side view showing a first step in the dispensing process of the machine of FIG. 1;

FIG. 6 is the same as FIG. 5 but showing the next step of the process;

FIG. 7 is the same as FIG. 6 but showing the next step of the process;

FIG. 8 is the same as FIG. 7 but showing the next step of the process;

FIG. 9 is the same as FIG. 8 but showing the next step of the process;

FIG. 10 is the same as FIG. 9 but showing the next step of the process;

FIG. 11 is a perspective view of parts of the dispenser of FIG. 1, including the main product cylinder, the portioning cylinder, and the dispensing cylinder as well as the actuators which control the movement of plungers in those cylinders;

FIG. 12 is a perspective view of the inside of the door of FIG. 1 partially as well as the actuators which control the movement of plungers in those cylinders;

FIG. 12 is a perspective view of the inside of the door of FIG. 1 partially broken away;

FIG. 13 is a perspective view of the upper cover half for the main product cylinder, the portioning cylinder, plunger, and actuator, and the dispensing cylinder, plunger and actuator of FIG. 1;

FIG. 13A is a side sectional view through the cover, portioning cylinder, and dispensing cylinder of FIG. 13;

FIG. 13B is a top view of the cover of FIG. 13;

FIG. 13C is a side view of the portioning cylinder of FIG. 13;

FIG. 14 is a schematic side view of the dispenser of FIG. 1;

FIG. 15 is the same view as FIG. 14 but showing the storage platform partially pivoted forward;

FIG. 16 is the same view as FIG. 15 but showing the storage platform fully pivoted forward for loading spare product;

FIG. 17 is a side view of the storage platform of FIG. 14;

FIG. 18 is a front view of the storage platform of FIG. 14;

FIG. 19 is a side view of the tube which provides the fluid path from the main product cylinder to the product outlet of the machine of FIG. 1;

FIG. 20 is a top view of the tube of FIG. 19;

FIG. 21 is a bottom view of the tube of FIG. 20;

FIG. 22 is a side view of an alternative tube to provide the fluid path from the main product cylinder to the product outlet without the use of a portioning cylinder;

FIG. 23 is a top view of the tube of FIG. 22;

FIG. 24 is a bottom view of the tube of FIG. 22;

FIG. 25 is a sectional view of the dispensing tube of FIGS. 19 and 22;

FIG. 26 is an enlarged view of the bottom portion of the dispensing tube of FIG. 25;

FIG. 27 is a sectional view through the dispensing tube, portioning and dispensing cylinder of the machine of FIG. 1;

FIG. 28 is a schematic of the portion of the pneumatic control system for the machine of FIG. 1 which controls the portioning and dispensing actuators;

FIG. 29 is a schematic of the portion of the pneumatic control system of the machine of FIG. 1 which controls the main product cylinders; and

FIG. 30 is a schematic for an alternate electrical control system to control the machine of FIG. 1.

### DESCRIPTION OF THE PREFERRED EMBODIMENT

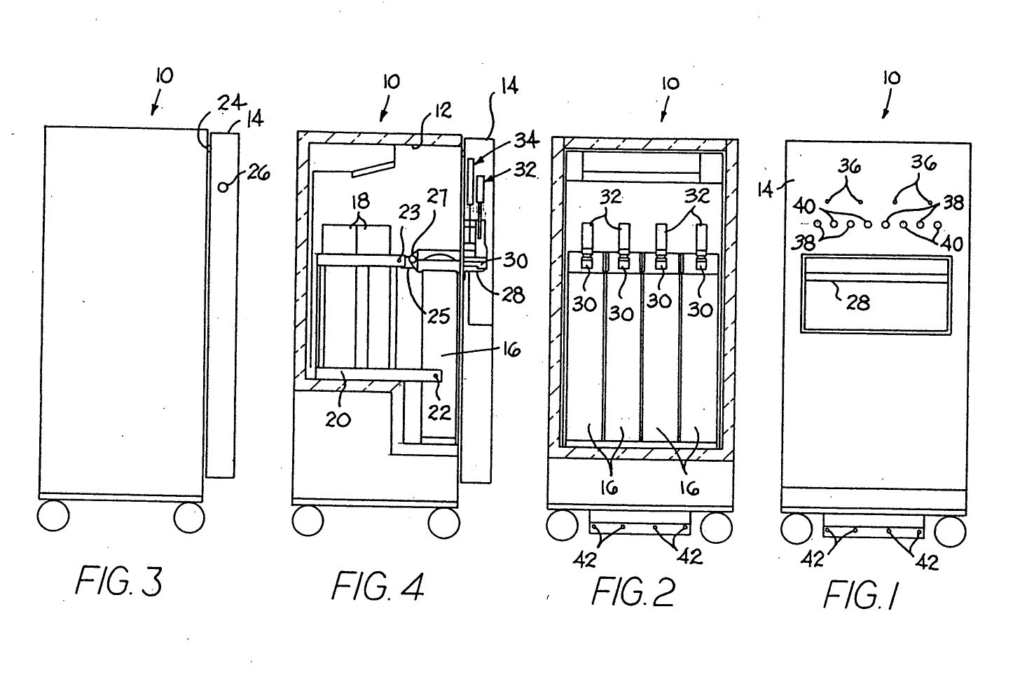

FIGS. 1-4 are schematic views of an example of a dispending machine 10 made in accordance with the present invention. THE machine 10 includes a refrigerated storage chamber 12 and a door 14 which pivots relative to the housing of the refrigerated storage chamber 12 so that, in a first position, the door 14 closes the storage chamber 12, and, in a second position, the door 14 provided access into the storage chamber 12.

This particular machine 10 dispenses four cylinders of product at any given time. Obviously, the number of cylinders form which the dispenser is designed can be varied, depending on the customer's needs. The four main product cylinders 16 stand adjacent to each other in the front of the refrigerated tempering and storage chamber 12. Extra product 18 is stored on a storage platform 20 behind the main product cylinders 16. The storage platform 20 rests on the bottom of the storage chamber 12 and is mounted to the sidewalls of the refrigerated chamber 12 at left and right pivot points 22. There is a bar 23 extending along the platform 20 in from of the extra product bags 18, and there are left and right linkage plates 25, pivotably connected to the platform bar 23 and to a main product cylinder bar 27.

On the inside surface of the door 14 is a spring-biased button 24, which is depressed when the door closes and which projects outwardly when the door opens. This serves as a sensor. On the side of the door 14 is another button or a key lock 26, which is manually shifted in position in order to signal the control system to unlock the door 14. There are holes 28 through the door, which permit product-dispensing tubes 30 to extend through from the inside of the door to the outside of the door. Inside the door 14 are dispenser actuators 32 and portioning actuators 34. On the front surface of the door 14 are lights or other “ready” indicators 36, small portion buttons 38, and large portion buttons 40. Also on the front of the machine 10, below the door 14, are foot actuator pedals or buttons 42.

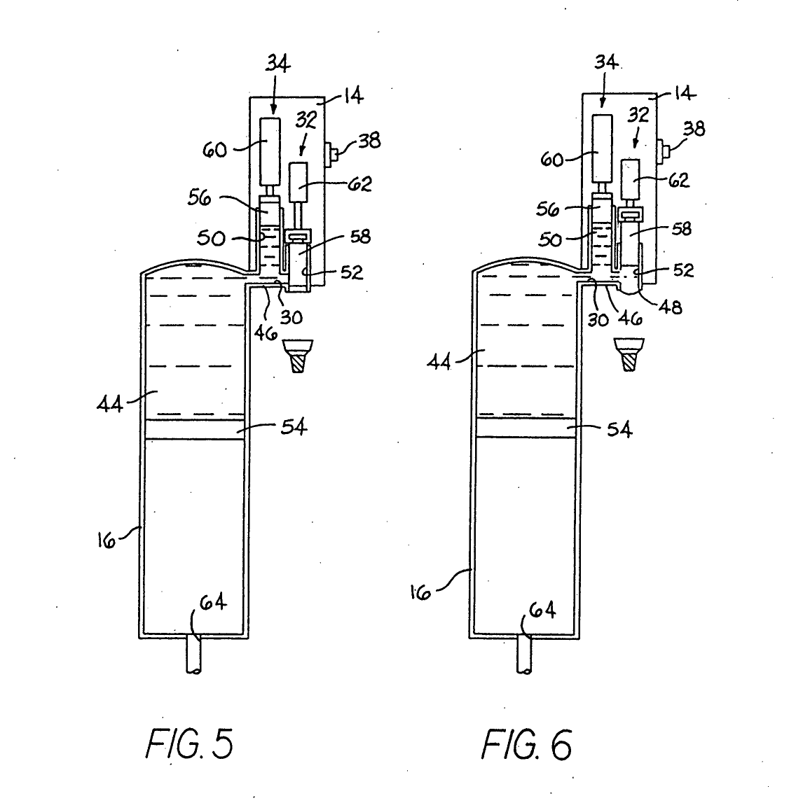

FIGS. 5-10 show schematically the main operating components of the dispenser 10 and the normal sequence for dispensing product. A spare bag 18 of product 44 is placed inside a main product cylinder 16. A dispensing path 46 is provided between the main product cylinder and the product outlet 48 by the tube 30. Along the dispensing path 46 are a portioning cylinder or chamber 50 and a dispensing cylinder or chamber 52, which will be described in more detail later. There is a main piston 54 in the main product cylinder 16, which pushes product 44 out of the main cylinder 16 to dispense the product 44 from the machine 10. There is a portioning plunger 56 in the portioning cylinder 50, and there is a dispensing plunger 58 in the dispensing cylinder 52. There is a portioning plunger actuator cylinder 60, and there is a dispensing plunger actuator cylinder 62, which actuate their respective plungers 56, 58. The main dispensing cylinder 16 has a flexible cylindrical bag of product 44 inside. It should be noted that the portioning cylinder 50 has a much smaller diameter of approximately six to ten inches, the portioning chamber 50 may have a diameter of approximately two inches.

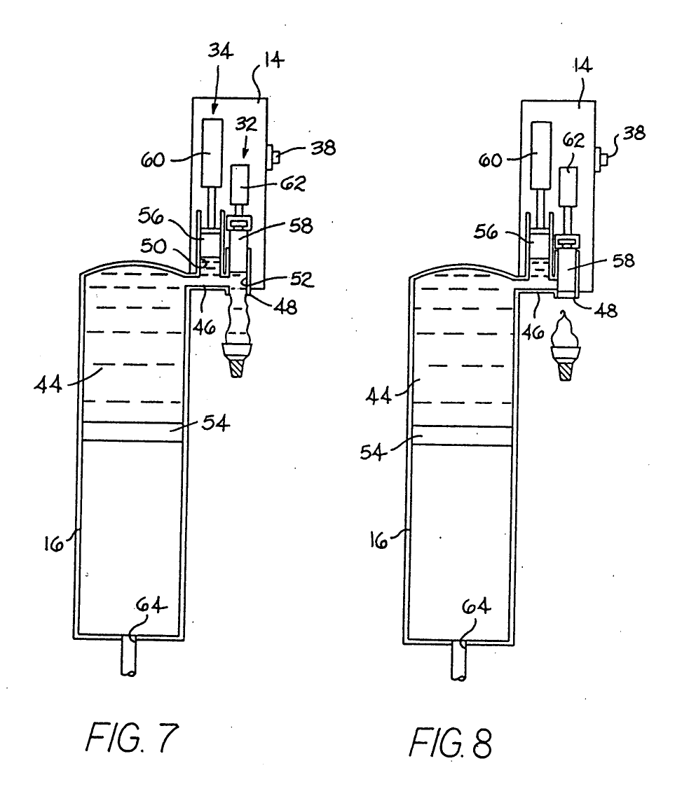

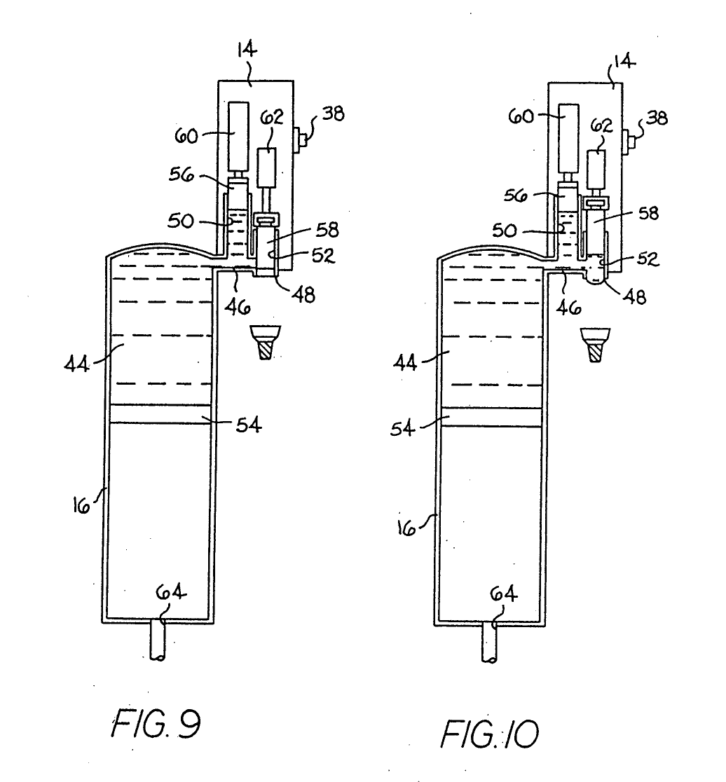

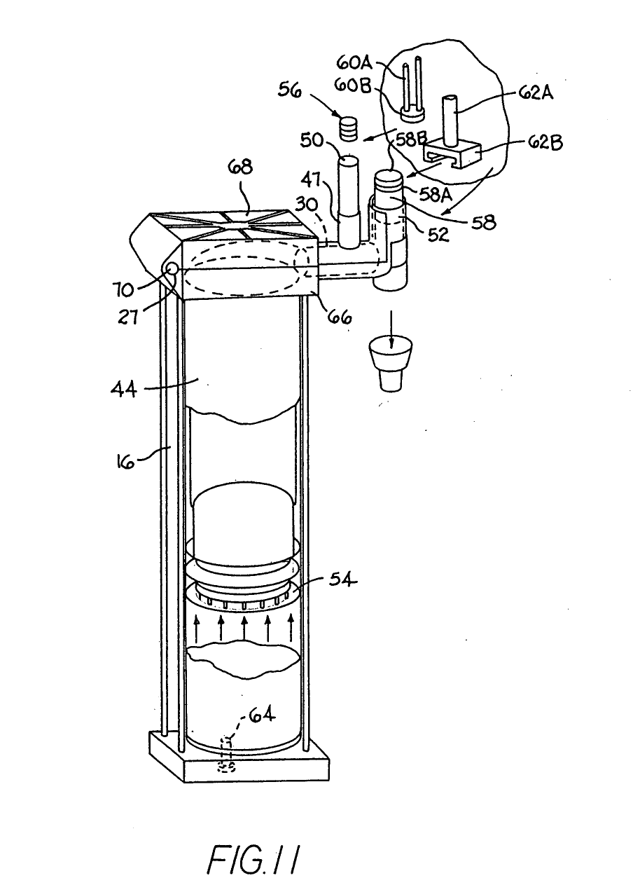

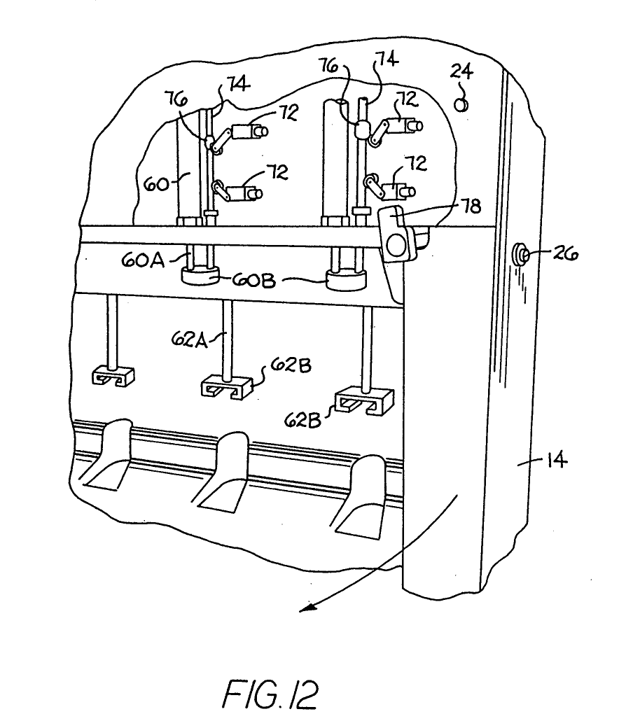

FIG. 5 shows the normal starting point. In order to dispense one portion, the operator checks to be sure that the “ready” indicator 36 for that particular dispenser is on, indicating that the dispenser is ready to dispense product, and then the operator depresses a dispensing button 38 or 40, selecting the portion size to be dispensed. This causes the piston 56 to be extended to dispense a portion of product. FIG. 6 shows the dispensing plunger 58 retracting. FIG. 7 shows the portioning plunger 56 extending to push product 44 out the outlet 48. Once the product has been dispensed, the dispensing plunger 58 is extended to close off the outlet 48, and the main piston 54 is pushed upwardly to refill the portioning chamber 50, as shown in FIG. 8. This returns the machine to the initial position, as shown in FIG. 9, where the process can be repeated, as shown in FIG. 10.

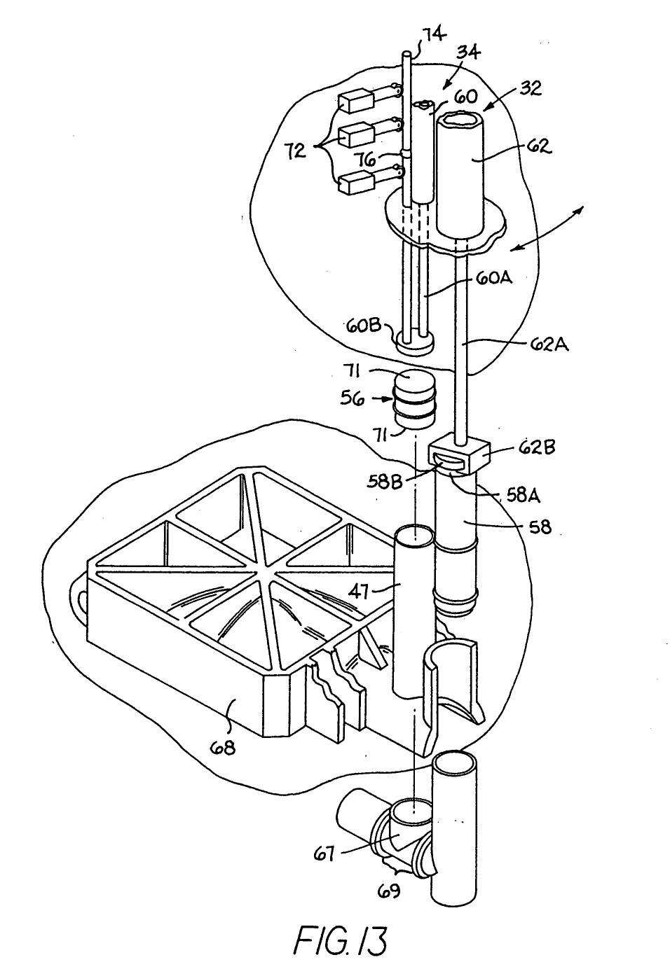

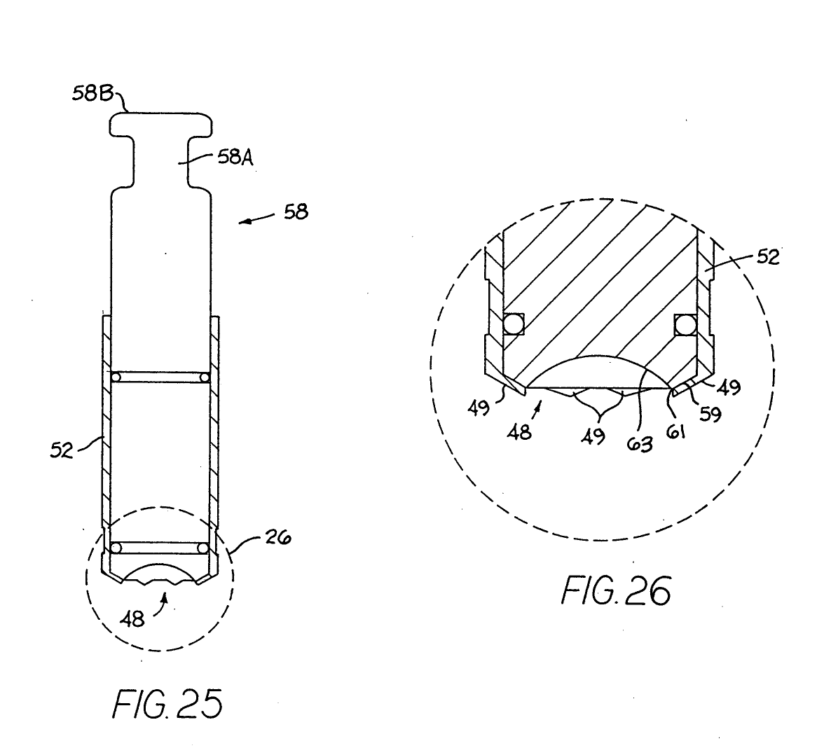

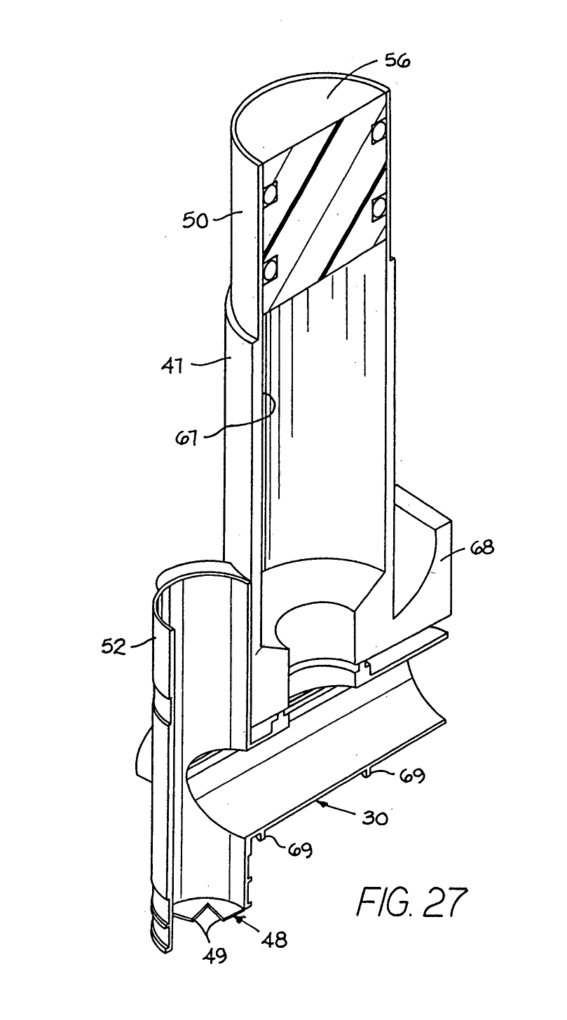

FIGS. 11-13C, 19-21, and 25-27 show the fluid pathway and the main moving parts in more detail. The cylinder 16 has a bag 18 of product 44 inside and has a plunger or piston 54, which seals against the internal wall of the cylinder 16. A fluid, preferably air, is received below the piston 54 through a port 64 in order to push the piston upwardly. In order to retract the piston 54, a vacuum is pulled though the port 64, as will be described later. Fixed to the tope of the cylinder 16 is a lower cover half 66. An upper cover half 68 is hinged to the lower cover half 66 about the pivot axis 70, which is the axis of the tube 27, which extends through all the cover halves 66, 68. The upper and lower cover halves 69, 66 surround and support the dispending tube 30, which has one end inside the bag 18 of product 44 and the other end forming the outlet 48. A portioning cylinder 50 fits into the sleeve and is locked into position with a twisting motion, as will be described later. When the upper and lower cover halves 68, 66 are clamped together, as is well known in the art, the bottom surface of the portioning cylinder 50 abuts and seals against an O-ring seal 73 on an upwardly-projecting sealing surface of an upwardly-directed opening 67 in the tube 30. Flanges 69 on the outer surface of the tube 30 keep the tube centered in its proper position with respect to the cover. The tube 30 projects inside of the spout (not shown) on the bag 18 and seals against the bag's spout, thereby providing a sealed pathway from the inside of the bag 18 through the tube 30 to the outlet 48, as is well known in the art. (The portioning cylinder sleeve 47 and portioning cylinder 50 are not part of the typical tube 30 known in the art.)

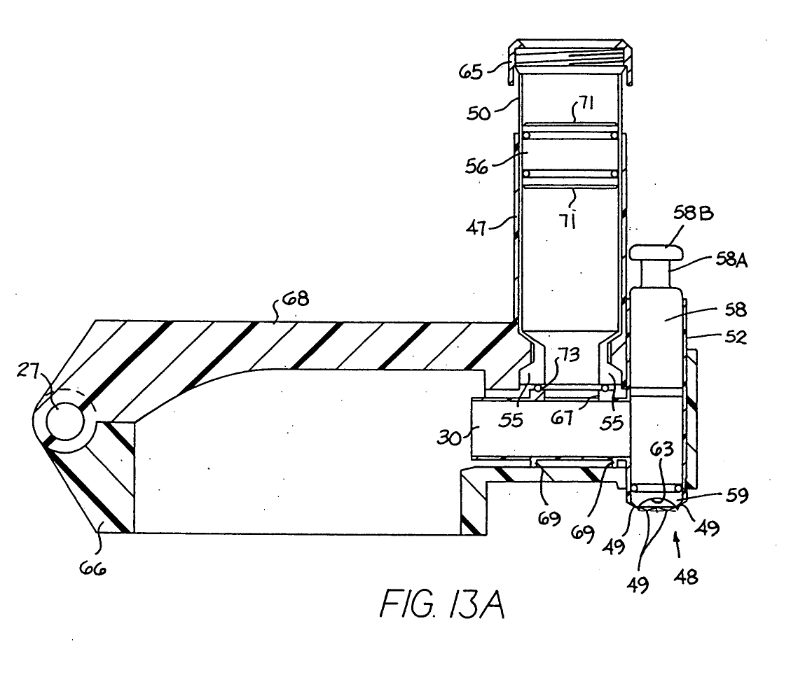

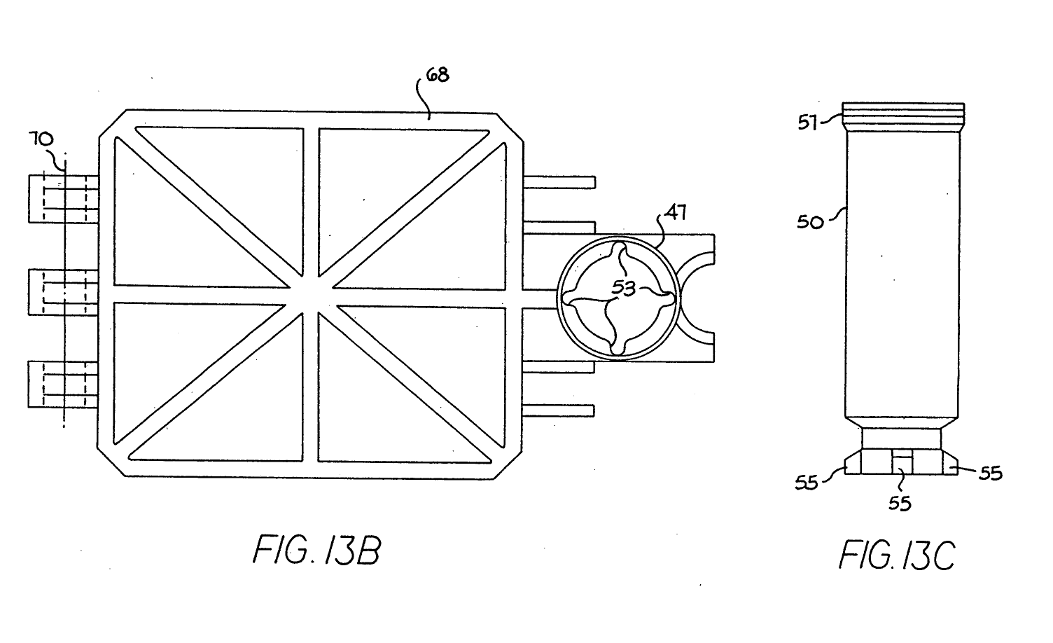

The inner surface of the portioning sleeve 47 is tapered inwardly at the bottom and defines four vertical grooves 53. The portioning cylinder or chamber 50 has a corresponding taper near the bottom, and terminated at its bottom edge with wings 55, which, for installation, slide down the vertical grooves 53 to a point below the grooves 53. The portioning cylinder 50 is then twisted, thereby locking the portioning cylinder 50 in position on the upper cover half 68 as shown in FIG. 13A. The portioning cylinder 50 is made as a separate, removable piece for ease in cleaning. The top outer edge of the portioning cylinder 50 defines threads 57, and a cap 65 is threaded onto the top edge of the cylinder 50 to prevent the portioning plunger 56 from accidentally lifting completely out of the portioning cylinder 50. The cap 65 projects inwardly only far enough to stop the plunger 56, but is otherwise open, in order to permit the portioning actuator 60 to act on the plunger 56 from above. The portioning plunger 56 fits down into the portioning cylinder 50 and seal against the inner surface of the portioning cylinder 50 by means of O-ring seals. It can be seen in FIGS. 11, 13, and 13A that the portioning plunger 56 has a simple cylindrical shape with flat top and bottom surfaces 71.

The dispensing plunger 58 is also cylindrical in shape, but it has a groove 58A in its outer surface, which defines a circular flange 58B. It also has grooves which receive O-ring seals, and it has a tapered outer surface near the bottom and a concave bottom surface, which will be described below. This shape of the dispensing plunger 58 is preferred, because it does not Interfere with closing the upper cover half 68 with the plunger 58 in place, and because it does not require the plunger 58 to have any particular orientation in order to connect to its actuator when the door closes. It should be noted that, during operation of the dispensing machine 10, the locations of the portioning chamber 50 and dispensing chamber 52 remain fixed relative to the cylinder 16, and the plungers 56, 58 remain in their respective chambers 50, 52, so when the door opens and closes, the plungers 56, 58 must separate from and then rejoin their respective actuators 32, 34 as indicated by the arrows in FIG. 11.

The bottom of the dispensing cylinder 52 and its respective dispensing plunger 58 have a special shape which helps prevent product from sticking to the dispenser and dripping after the dispensing cylinder is closed. The dispensing cylinder or housing 52 is cylindrically-shaped, but, at the outlet 48, there are inwardly and downwardly projecting, pointed leaves 49 extending from the cylindrical side wall of the cylinder 52. The dispenser plunger 58, at its lower edge, defines an inwardly and downwardly tapered surface 59, which intersects at circle 61 with a central concave surface 63. The circle 61 contacts the points of the leaves 49 when the plunger 58 is down, and the tapered surface 59 of the plunger 58 lays at the same angle as the leaves 61 and firmly contacts the inner surface of the leaves 49. The firm contact between the tapered surface and the leaves, the spacing between the leaves, and the intersection of the circle 61 with the points of the leaves provides little opportunity for product to adhere to the dispenser outlet 48. This greatly reduces any dripping problem.

The actuators 32, 34 preferably are fluid-operated cylinders 60, 2 as shown in these figures, although electrically-operated actuators could also be used. A portioning piston rod 60A projects from the portioning actuator cylinder 62. At the bottom of the portioning piston rod 60A is a flat disk 60B. At the bottom of the dispensing actuator 62A is a flat receptacle 62B, having a C-shaped cross section. The C-shaped receptacle 62B receives and hooks around the flange 58B of the dispensing plunger 58 so it can raise and lower the dispensing plunger 58 as the dispensing piston rod 62A travels up and down. The dispensing cylinder 62 preferably is spring-biased downwardly.

As part of the control system, switches 72 are mounted inside the door 14. The number of switches 72 is selected depending upon the number of different portion sizes to be dispensed by the dispenser. FIG. 13 shows three switches 72 for a dispenser that dispenses two portion sizes, and FIG. 12 shows two switches for a dispenser that dispenses a single portion size. A contactor rod 74 is mounted to move up and down with the portion actuator rod 60A, and the contactor rod 74 includes a contactor 76, which is fixed on the contactor rod 74 and contacts the switches 72 as it travels up and down. This controls the portion size, as will be explained later. A locking latch 78 is provided on the inside of the door 14 and is rotated by the control system which is actuated by the key or bottom 26 on the side of the door. The locking latch is received in a slot (not shown) on the wall of the refrigerated chamber 12 to lock the door.

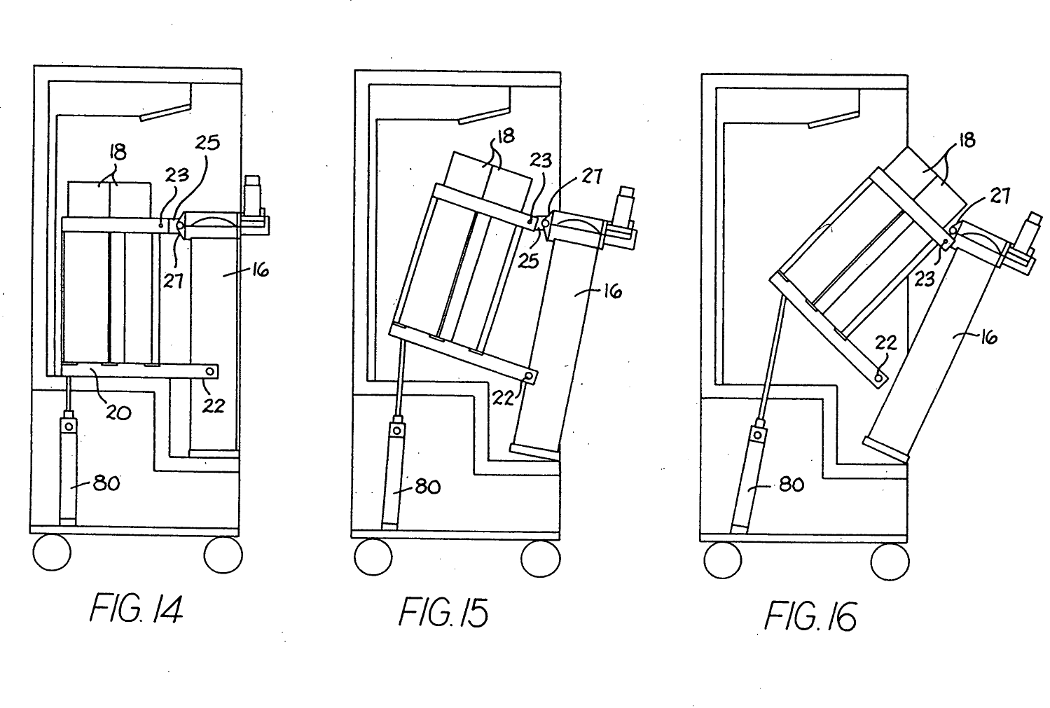

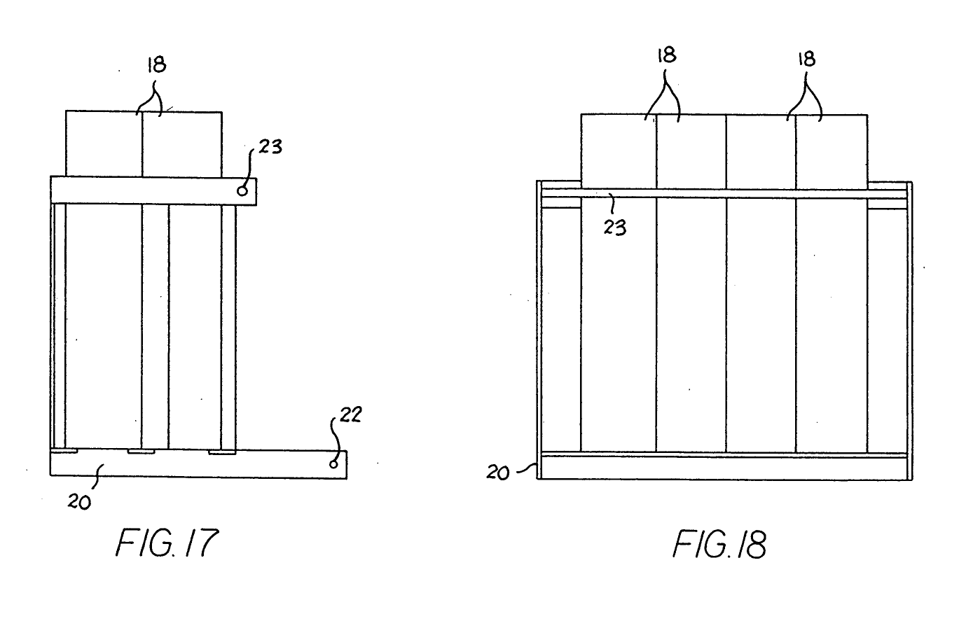

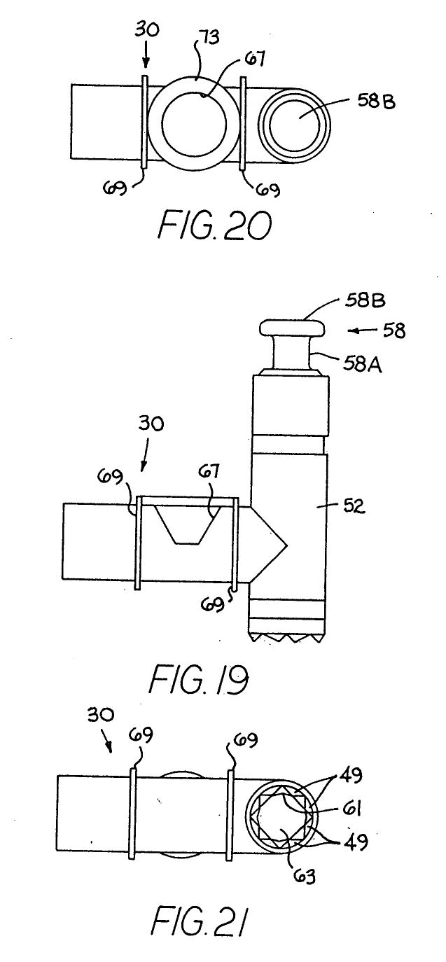

FIGS. 14-18 show a lift and tilt system, which helps shift stored bags 18 of product upwardly and forwardly to make it easier for the operator to reach them when it is time to re-load a main product cylinder. The extra containers 18 of product 44 are stored within the tempering-refrigeration chamber 12 behind the dispensing cylinders 16 on the platform 20. The platform 20 is raised and lowered by a lift cylinder 80, which is actuated by a manually-operated switch. Then the cylinder 80 is pressurized, it causes the platform 20 to shift upwardly and forwardly, pivoting about the pivot points 22. This also pivots the main cylinders 16 forward, making the extra containers 18 readily accessible. Once an extra container 18 has been removed form the tempering-refrigerated chamber and set aside, and perhaps another container 18 has been placed onto the platform 20 for tempering, the operator actuates a switch to retract the cylinder 80, returning the platform to its initial position. This lift and tilt system can only be activated when the service door 14 is open.

The normal sequence for reloading the product cylinders 16 is as follows:

First, the door 14 is opened. Then the operator activates a switch, which causes the platform 20 to pivot forward. Then the operator removes a stored bag 18 from the platform, sets it aside, activates a switch to return the platform 20 to its original position, and closes the door 14. Then, the operator puts a clean tube 30 on the new bag 18, pressing the tube 30 against the opening in the bag to seal the tube to the bag. Then, the operator opens the door 14, opens the upper cover 68 for the main product cylinder 16 to be refilled, hits the foot pedal for that cylinder to pull the main plunger 54 down a bit, and removes the used product bag. Then the operator takes the newly prepared bag 18 with tube 30 installed, set it on the plunger 54, and presses and holds the foot switch to retract eh plunger 54, guiding the bag 18 as it travels downwardly with the plunger 54. Then the operator closes the upper cover 68 and clamps the upper and lower cover halves together. Then the operator closes the door 14 and the machine is ready to dispense the new product.

The only parts of the dispenser that contact product are the bag 18, the tube 30, the portioning chamber 50 and portioning plunger 56, and the dispensing chamber 52 and dispensing plunger 58. The bag 18 generally is thrown away when it is empty, although I could be recycled. The other contact parts can readily be removed and replaced with clean parts, and the used parts can be brought to a sink or washbasin and cleaned for re-use later.

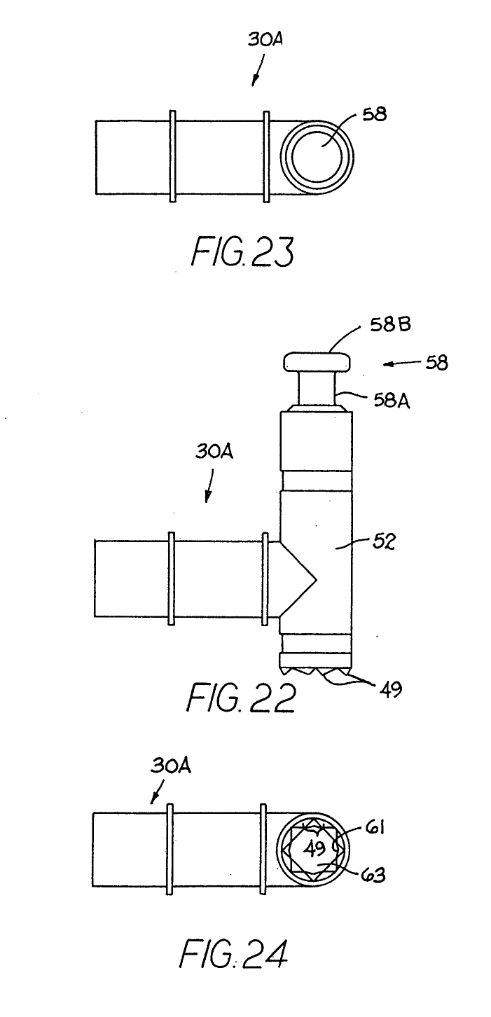

FIGS. 22-24 show an alternative embodiment of a tube 30A, which could replace the tube 30 if portion control is not desired. If this tube 30A were used, the operator would simply press the dispensing button for the desired time period to dispense product.

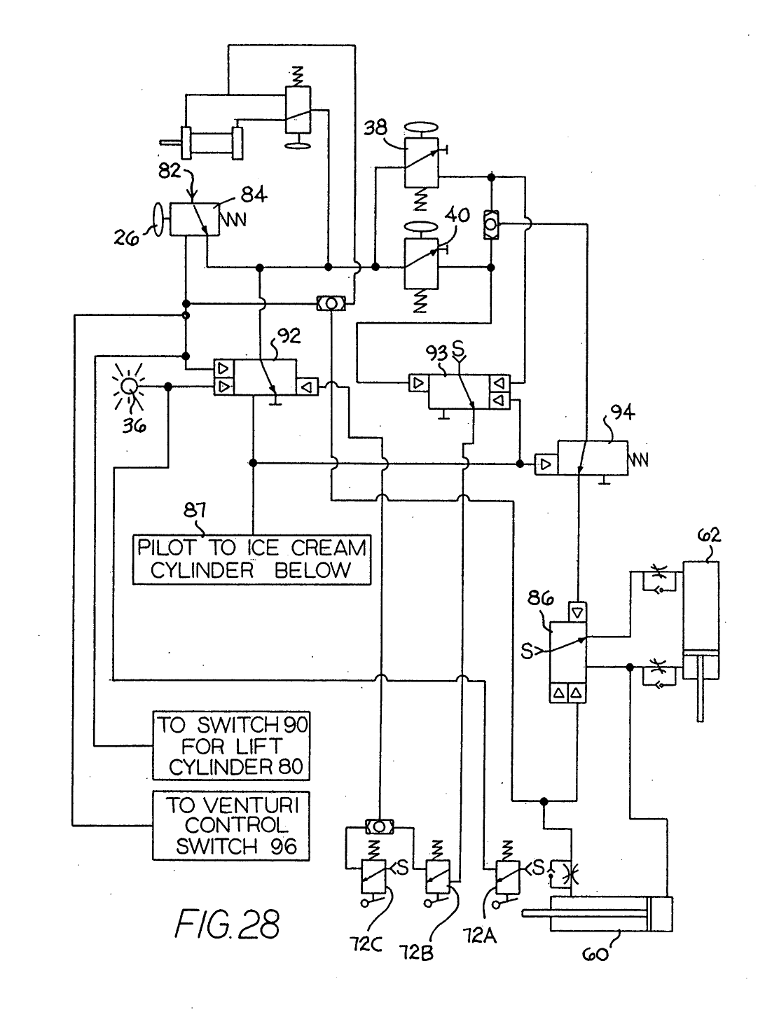

The schematic of the control system for the machine of FIG. 1 is shown in FIG. 28. In this preferred embodiment, the control system is pneumatic and includes a pneumatic circuit board. While the schematic shown in FIG. 28 is for a single product cylinder dispenser, it is understood that the dispensing machine is intended to have a plurality of dispensers, so some parts of the system will be repeated multiple times in one machine. For example, in the preferred embodiment, there are four dispensing cylinders 16 in the machine and four corresponding small portion and large portion buttons and actuators for the four cylinders.

The dispenser actuator cylinder 62 and the portioning actuator cylinder 60 are shown on the right side of the schematic. There is a compressor (not shown), which provides pressurized air to run the system. The pressurized supply sir enters the system at the point 82 and enters through the door switch valve 84, which is activated by the door open button 26, when the door is open. FIG. 28 shows the position of the door switch valve 84 when the door is closed. The machine will only dispense product when the door 14 is closed. Supply air is also provided to various valves at points indicted by the letter “S”.

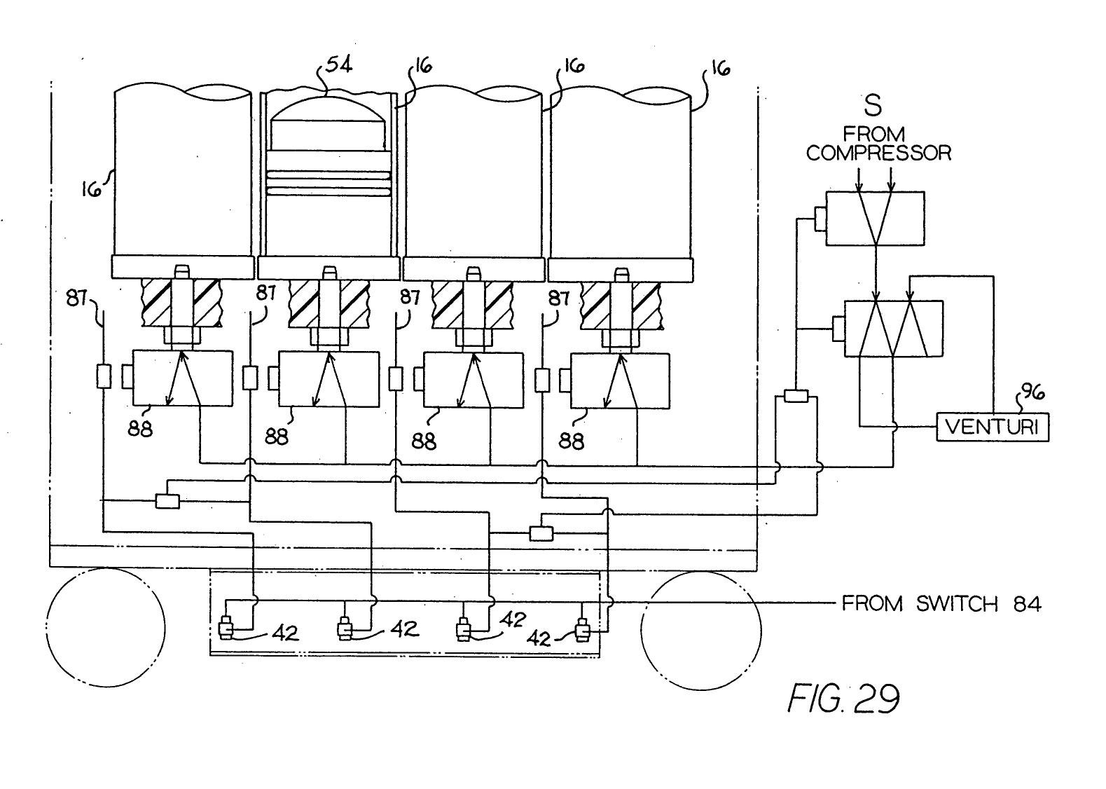

When the service door 14 is open, the door switch 84 causes the dispenser actuator valve 86 to send supply air to the top of the dispenser actuator cylinder 62, which extends the dispensing plunger 58 to close off the outlet 48. When the door is open, it also causes supply air to be sent to the bottom of the portion actuator control cylinder 60, retracting the portioning control cylinder 60. It also prevents a pilot signal from the portion control form passing to pilot the ice cream cylinder valve 88, shown in FIG. 29, which prevents the man piston 54 from pushing product out of the main cylinder 16. It also permits the manual valve 90 to be activated by the operator, to cause the platform lifting cylinder 80 to be extended, lifting the product support platform 20 and to be retracted, returning the support platform 20 to its starting position.

When the service door is closed, the door switch 84 moves to its second position, shown in FIG. 28. In this position, supply air is connected to the large and small portion start buttons 38, 40 and to the first sequencing control valve 92.

To dispense a large portion of product, the operator first pushes the large product start buttons 38, which permits supply air to pass through the large portion start valve 38 to the small/large pilot control valve 93, shifting that valve to the left, so that the dispensing will not stop until the portioning actuator 60 sees contact with the lowermost portioning switch 72C. The air passing through the large portion valve 38 also passes through a shuttle valve to the pilot valve 94. Unless the main piston 54 is being pushed, which would close off the pilot valve 94, the valve 94 will then provide pressure to the top of the valve 86, moving it to its second position, which permits supply air to enter the bottom of the dispensing plunger 58. It also sends supply air to the top of the portioning actuator cylinder 60, which moves the portioning plunger 56 down. The portioning plunger 56 will continue to move downwardly, dispensing the product, until the lowermost switch 72C is contacted by the contactor 76, at which point supply air will pass through the switch 72C, through a shuttle valve, and will pilot the first sequence control valve 92 to the left, causing supply air to pass through the first sequence control valve 92 to cause compressed air to raise the main piston 54, and causing the pilot valve 94 o shift to the right and the small/large pilot valve to shift to the left. The air going through the lowermost switch 72C will also cause the dispensing actuator 62 to shift downwardly, closing the outlet, and relieves pressure from the portioning cylinder 60, so that the product being pushed up by the main piston 54 will fill the portioning chamber 50, causing the portion actuating cylinder 60 to move upwardly until the uppermost switch 72A is tripped by the contactor 76.

It also causes the sequencing valve 92 to shift to the right, relieving air pressure from the main dispensing cylinder 16, and readying the system for the next time an operator presses a button 38 or 40. When the upper position switch 72A is switched, it gives a signal to the “Ready Indicator” 36, telling the operator that the machine is ready again to dispense product.

To dispense a small portion, the operator presses the small portion button 40, which allows air to pass through the door switch valve 84, through the small portion switching valve 40, to the left side of the small/large pilot valve 93 shifted to the right, supply air passes through the small/large pilot valve 93 to the middle switch 72B, so that, when the middle switch 72B is tripped, the first sequence control valve is shifted to the left, the dispensing actuator is shifted downwardly, pressure is relieved form the portioning actuator cylinder 60, and the main cylinder 16 is pressurized pushing the product up, out of the main cylinder 16 in order to refill the portioning chamber for next time. While this schematic does not show a payment receiving control (such as a coin or bill or credit card receiver) which must be activated before the valves 38, 40 can be activated, it will be obvious that such a modification may be made in order to make this machine completely self-vending, so that it could be placed in a public location for direct access by customers.

The portion of the control system providing compressed air or vacuum to the bottom of the main dispensing cylinder is shown in FIG. 29. The pilot signal 87 coming from the lower left side of the schematic on FIG. 28 enters its respective point in FIG. 29. When a pilot signal is received into the cylinder 16 to push product up, out of the cylinder 16. Alternatively, if the door 14 is open and one of the foot switched 42 is depressed, air will pass through the door switch valve 84 through the foot switch 42, to the shuttle valve for the respective cylinder 16, again opening a path onto the cylinder 16. However, in this case, the pressurized air supply S coming form the compressor will be passed through a Venturi circuit, drawing a vacuum on the bottom of the respective cylinder 16 and pulling the piston 54 down. If there is no pilot signal 87 and the door is closed (or the door is open and the foot switch 42 has not been depressed), then the main cylinder control valve 88 vents the bottom of the main cylinder 16 to atmosphere. It is very advantageous that the controls for this system are fluid-operated, as this avoids the problem of having electrical coils for an electrical control system in the area, where they would tend to heat the product.

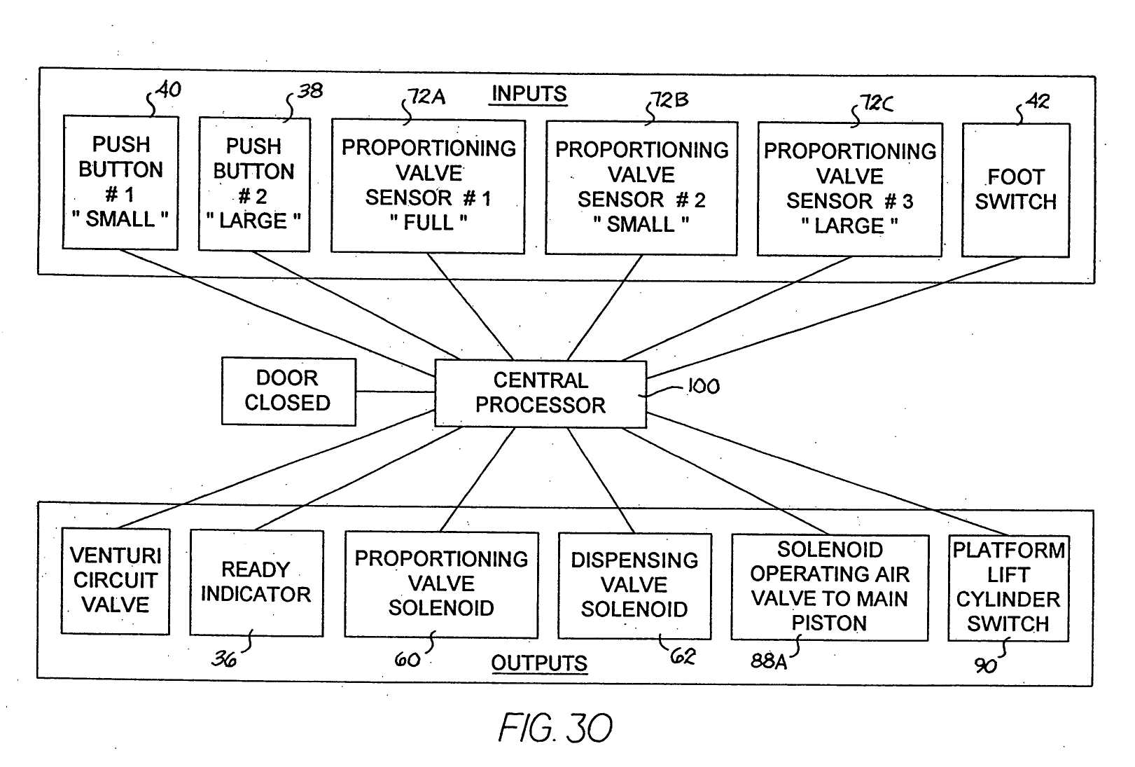

FIG. 30 shows an alternative control system, in which electrical controls are used instead of the pneumatic controls described above. In this case, there would be a central processor 100, which would receive inputs from the various operator-actuated controls and the sensors and which would then transmit signals to the appropriate actuators (usually solenoid valves) to open and close the valves to operate the machine as described earlier.

It will be obvious to those skilled in the art that modifications may be made to the embodiments described above without departing from the scope of the present invention.

1. An automatic dispenser, comprising:
a main dispensing chamber;
a portioning chamber in fluid communication with said main dispensing chamber;
an outlet valve in fluid communication with said portioning chamber; and
a control system controlling the movement of a manual plunger in said main dispensing chamber, a portioning plunger in said portioning chamber, and said outlet valve so as to dispense portions of product.

2. An automatic dispenser as recited in claim 1, wherein the cross-section of the main dispensing chamber perpendicular to the direction in which the main plunger moves is substantially larger than the cross-section of the portioning chamber perpendicular to the direction in which the portioning plunger moves.

3. An automatic dispenser as recited in claim 1, wherein the dispenser includes a storage chamber which houses the main dispensing chamber; and a door which opens and closes to provide access to the main dispensing chamber through said door.

4. An automatic dispenser as recited in claim 3, wherein said door houses the control system for controlling said outlet valve and said portioning plunger.

5. An automatic dispenser as recite din claim 4, wherein said control system is fluid operated.

6. An automatic dispenser as recited in claim 4, wherein said control system is electrically-operated.

7. An automatic dispenser, comprising:
a main chamber, housing a main cylinder and a main plunger which operates said main cylinder;
a door, which provides access to said main chamber, said door containing a portioning actuator; an outlet valve actuator; and an outlet port.

8. An automatic dispenser as recited in claim 7, wherein said portioning actuator and outlet valve are fluid-operated cylinders.

9. An automatic dispenser as recited in claim 8, and further comprising a fluid path from said main cylinder to said outlet port; a portioning chamber in fluid communication with said fluid path; a portioning plunger in said portioning chamber; an outlet cylinder in said fluid path, said outlet cylinder defining said outlet port; and an outlet plunger in said outlet cylinder.

10. An automatic dispenser as recited in claim 9, wherein said portioning actuator controls said portioning plunger, and said outlet valve actuator controls said outlet plunger.

11. An automatic dispenser as recited in claim 10, wherein said portioning chamber has a substantially smaller diameter than said main cylinder.

12. An outlet valve for a dispenser, including a housing defining an outlet opening; a dispending plunger movable in said housing form a lowered, closed position, to a raised, open position, wherein said housing has an interior surface which defines a vertical, cylindrical wall, which, at its lower end, terminated with inwardly-and downwardly-directed leaves; and therein said dispensing plunger has an outer, cylindrical surface which fits in the interior surface of said housing and at its lower end includes an inwardly-tapering portion which taper inwardly and downwardly at the same angle as and mates snugly with the leaves when said dispensing plunger has a concave bottom surface which intersects said inwardly-tapering portion at a circle.

13. An outlet valve as recited in claim 12, wherein said leaves terminate at innermost points, and when said dispensing plunger is in the closed position, said circle is aligned with said innermost points of said leaves.

14. A dispensing machine, including:
a main chamber;
a door which closes off said main chamber in a first position and provides access to said main chamber in a second position;
at least one main cylinder in said main chamber; an opening through said door; and a fluid pathway form said main cylinder to said opening in said door.

15. A dispensing machine as recited in claim 14, wherein said platform is connected to said main cylinder so that, as said platform shifts forward, said cylinder also shifts forward.

16. A dispensing machine, comprising:
a main storage chamber;
at door which, in one position, closes off said storage chamber, and in another position, provides access into said main storage chamber, said door defining a dispensing opening;
at least one man cylinder in said main storage chamber;
a fluid path from said main cylinder through said dispensing opening, said fluid path including a tube extending from said cylinder to said dispensing opening, wherein said tube includes a cylindrical housing from an open position, permitting product to travel through said tube and through said dispensing opening, to a closed position, which prevents product from traveling out said tube to be dispensed, said tube being mounted to said cylinder; and said dispensing valve defining a circular flange at one end.; and
a dispenser actuator mechanism mounted on said door, including a receptacle which, when said door is closed, mates with said circular flange so that, as said dispenser actuator mechanism shifts from one position to another, it moves said dispensing valve to its open and closed positions, and which, when said door opens, releases said circular flange.

17. A dispenser, comprising:
a main storage chamber;
at least one main product cylinder in said main storage chamber;
a source of pressurized fluid;
a fluid path form said source of pressurized fluid to said main product cylinder; and;
a control system for controlling the flow of fluid from said source of pressurized fluid to said main product cylinder, including a foot-operated controller, located near the bottom of said main storage chamber and a Venturi valve, such that, upon actuating said floor-operated controller, said pressurized fluid is directed through said Venturi, creating a suction which communicated with said main product cylinder.

18. A dispenser, comprising:
a main storage chamber;
at least one main product cylinder in said main storage chamber;
a source of pressurized fluid;
a fluid path from said source of pressurized fluid to said main product cylinder; and
a pneumatic control system for controlling the flow of fluid from said source of pressurized fluid to said main product cylinder, including a fluid path past a Venturi valve; and pneumatically-controlled valves which selectively provide pressurized air and vacuum to said main product cylinder to selectively dispense product from said cylinder.
